(19) United States
(12) Patent Application Publication
(10) Pub. No.: US 2018/0164899 A1
(43) Pub. Date: Jun. 14, 2018

(54) CONTROL FOR THE SAFE CONTROLLING OF AT LEAST ONE MACHINE

(71) Applicant: SICK AG, Waldkirch (DE)

(72) Inventor: Markus SAUMER, Waldkirch (DE)

(21) Appl. No.: 15/830,199

(22) Filed: Dec. 4, 2017

(30) Foreign Application Priority Data
Dec. 9, 2016 (EP) 16203081.1

(51) Int. Cl. G06F 3/0338; G05B 19/418

(52) U.S. Cl. CPC G06F 3/0338; G06F 3/0482; G05B 19/41845

(57) ABSTRACT

To enable an intuitive configuration of a control (S) or of a total plant, a control (S) for the safe controlling of at least one machine (R, St) is provided comprising a control module (SM) for generating output signals in dependence on input signals, wherein the input signals are provided by at least one connected signal generator and the output signals are communicated to the at least one machine (R, St), and wherein the control module (SM) has a display (D, D1) for displaying information of the control (S), said display being movably supported in the control module (SM) such that a moving of the display (D), D1) with respect to the control module (SM) corresponds to an input to the control (S).

The invention relates to a control for the safe controlling of at least one machine.

A total plant is made up of a plurality of modules in today's automation industry, with each module having at least one control and at least one machine. A modification of the plant can be carried out simply and in a time-saving manner due to the modular structure of the plant.

The control of the plant controls the machine such that the machine carries out its associated work and optionally interacts with another machine. For this purpose, the control receives input signals from connected signal generators that, for example, reproduce an environment of the machine or a position or a movement of the machine. The control generates output signals that control the machine accordingly and communicates the output signals to the machine.

In this respect, the control comprises configuration data that enable the control to recognize the connected signal generators and machine and to control the functions thereof. These configuration data can be implemented in the control by means of an external input device, for example a computer.

The configuration can additionally be carried out directly at the control. The known control has rotary switches or a display and cursor keys for this purpose. Inputs and outputs of an input module or output module of the control can be set by means of the rotary switches, for example, with signal generators being connected to the input module and the machine to be controlled being connected to the output module.

Information with respect to the configuration or of the inputs and outputs of the input module and output module can also be displayed on a display of the control so that a user can select and carry out the configuration by means of the cursor keys. The user can select the information with respect to the configuration to be displayed on the display and can confirm the configuration.

This known kind of direct configuration of the control is not very intuitive for the user since the rotary switches or the association between the information displayed on the display and the cursor keys are not self-explanatory.

It is therefore an object of the invention to provide a control for the safe controlling of a machine with which an intuitive configuration of the control is possible.

The object is satisfied in accordance with the invention by a control for the safe controlling of at least one machine comprising a control module for generating output signals in dependence on input signals, wherein the input signals are provided by at least one connected signal generator and the output signals are communicated to the at least one machine, and wherein the control module has a display for displaying information of the control, said display being movably supported in the control module such that a moving of the display with respect to the control module corresponds to an input to the control.

In accordance with a preferred embodiment, the display is supported in a spring-loaded manner and is held in a starting position with respect to a housing of the control module. The display can hereby advantageously always return into the starting position after the input to the control.

In accordance with a further preferred embodiment, the moving of the display comprises a pressing of the display with respect to the control module and the display returns into its original position with respect to the control module after a release.

In accordance with a further preferred embodiment, the moving of the display furthermore comprises a tilting of the display with respect to the control module. The display is advantageously tiltable and pressable in nine directions with respect to the control module.

In accordance with a further preferred embodiment, different input options are displayed on the display such that the moving of the display in the direction of the respective input option by tilting or by pressing the display represents a selection confirmation of the input option. Two input options, such as “Reject” and “Accept” can, for example, be displayed at the left and right margins of the display and the user can confirm his selection by pressing or tilting the display to the left or to the right.

In accordance with a further preferred embodiment, the display comprises a light emitting diode display or a liquid crystal display.

At least one expansion module is furthermore advantageously connectable to the control module by at least one bus, with additional signal generators and/or machines being connectable to the expansion module. The control can hereby be simply expanded as required. The expansion module has a further movably supported display, with the display of the expansion module in particular being of the same type as the display of the control module.

The invention will also be explained in the following with respect to further advantages and features with reference to the enclosed drawing and to embodiments. The Figures of the drawing show in:

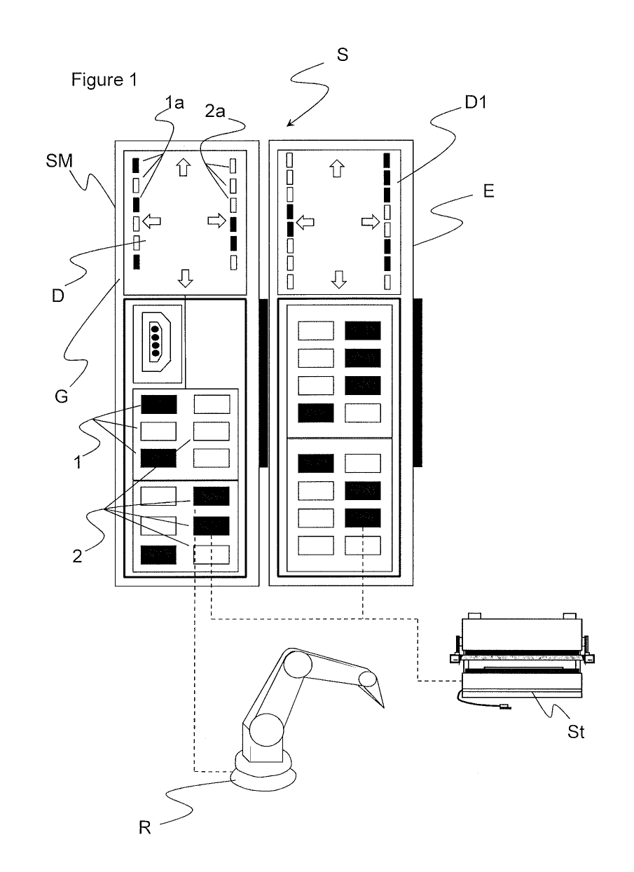

FIG. 1 a schematic representation of a control in accordance with the invention in an automation plant; and

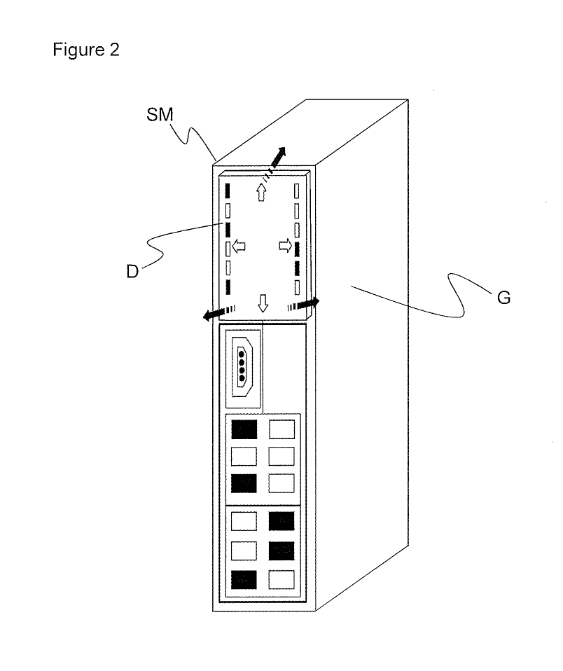

FIG. 2 a schematic perspective detailed representation of an embodiment of the control in accordance with the invention.

FIG. 1 schematically shows an automation plant that is built up of a control S in accordance with the invention and of two machines controlled by the control S. The control S controls the machines shown by way of example as a robot arm R and as a punch St.

The control S comprises at least one control module SM to which at least one signal generator, not shown, can be connected so that the control module SM receives received signals from the signal generator. The input signals are processed by the control module SM into corresponding output signals by which the control S safely controls the machines R and St. The control module SM communicates the output signals to the machines R and St for this purpose.

The control S can be expanded by at least one additional expansion module E so that the total plant can be expanded in a very simple manner. The additional expansion modules E are connected to the control S in accordance with the invention by means of a bus line for this purpose.

The control module SM has a display D on which information of the control S can be displayed. The information can, for example, reproduce the configuration information of the control module SM via the signal generator and the machines R and St and in particular which input and output connectors of the control module SM the signal generator and the machines R and St are connected to. The connectors, the connected signal generators or machines and connection options of the automation plant are, above all displayed by the control S on a configuration of the control S.

For this purpose, the display D of the control module SM is movably supported in accordance with the invention such that a moving of the display D with respect to the control module SM corresponds to an input to the control S. In other words, the display D of the control S in accordance with the invention has a functionality corresponding to a cursor key or accept key so that a user can intuitively carry out the association of the information displayed and thus the configuration on the configuration of the control S using the display D.

The display D is supported in a spring-loaded manner and is held in a starting position with respect to a housing G of the control module SM. The display D can be moved out of this starting position of the display D, with the moving of the display D comprising a pressing of the display D with respect to the control module SM and the display automatically returning into the starting position with respect to the control module SM on a release of the display D. The moving of the display D can in particular comprise a tilting of the display D with respect to the control module SM in which the user presses the sides of the display D so that the display D tilts in this direction.

The display D is advantageously tiltable and pressable in nine directions with respect to the control module SM, with an electric contact being established in the control module SM on each tilting or pressing of the display D that provides a corresponding functional signal to the control module SM or to the control S.

In other words, different input options for the user are shown on the display D such as an association of an input connector 1a of the control module SM to an output connector 2a of the same. The display on the display D digitally reproduces the arrangement of the physical connectors 1 and 2 of the control module SM or of the expansion module E. The user can provide a selection confirmation of the input option to the control module as a functional signal by moving the display D in the direction of the respective input option by means of tilting or pressing the display D so that the input of the user, in this case the association of the one digitally presented input connector 1a with the one digitally presented output connector 2a, is stored in the control module SM.

In the embodiment shown in FIG. 1, the control module SM has six input connectors 1 and six output connectors 2 that are assigned differently. The assigned connectors 1 and 2 are shown as black boxes and the non-assigned connectors 1 and 2 are shown as white boxes. These physical input and output connectors 1 and 2 are digitally exactly reproduced in the form of represented input and output connectors 1a and 2a on the display D in accordance with the invention so that so-to-say an image of the physical input and output connectors 1 and 2 is visible to the user. The display D here comprises a light emitting diode display or a liquid crystal display.

On the configuration or association of the connectors 1 and 2 of the control module SM, the user presses the display D in the desired direction so that the information shown in this direction is deemed to be selected and confirmed with respect to the control module SM. The user can in this manner completely intuitively select and input configuration data of the control S by means of the display D without having to operate separate cursor keys in so doing.

As shown, the expansion module E has a further movably supported display that is in particular of the same type as the display D of the control module SM. The configuration of the expansion module E can hereby be intuitively carried out in the same manner.

FIG. 2 perspectively shows the control module SM with the display D in accordance with the invention. How movably the display D is supported with respect to the housing D of the control module SM is indicated by the black arrows. The user can in particular press the display D at the corners, at the sides and at the center, whereby the display D is movable in nine directions in total. A different input option can be stored in every direction in this respect.

### REFERENCE NUMERAL LIST

1 input connector
1a digitally represented input connector
2 output connector
2a digitally represented output connector
D, D1 display
E expansion module
G housing
R, St machine (robot arm, punch)
S control
SM control module

1. A control for the safe controlling of at least one machine, the control comprising
a control module for generating output signals in dependence on input signals, wherein the input signals are provided by at least one connected signal generator and the output signals are communicated to the at least one machine; and
wherein the control module has a display for displaying information of the control;
wherein the display is movably supported in the control module such that a moving of the display with respect to the control module corresponds to an input to the control;
wherein the information of the control displayed on the display digitally exactly reproduces the physical input and output connectors and their different assignments; and wherein the input to the control represents a selection and a confirmation of the information displayed.

2. The control in accordance with claim 1, wherein the display is supported in a spring-loaded manner and is held in a starting position with respect to a housing of the control module.

3. The control in accordance with claim 2, wherein the moving of the display comprises a pressing of the display with respect to the control module and the display returns into the starting position with respect to the control module on a release.

4. The control in accordance with claim 2, wherein the moving of the display comprises a tilting of the display with respect to the control module.

5. The control in accordance with claim 1, wherein the display is tiltable and pressable in nine directions with respect to the control module.

6. The control in accordance with claim 1, wherein different input options are displayed on the display such that the moving of the display in the direction of the respective input option by tilting or pressing the display represents a selection confirmation of the input option.

7. The control in accordance with claim 1, wherein the display comprises a light emitting diode or a liquid crystal diode.

8. The control in accordance with claim 1, wherein at least one expansion module is connectable to the control module by means of a bus and additional signal generators and/or machines are connectable to the expansion module.

9. The control in accordance with claim 8, wherein the expansion module has a further movably supported display.

10. The control in accordance with claim 9, wherein the display of the expansion module is of the same type as the display of the control module.
